(19) United States
(12) Patent Application Publication
(10) Pub. No.: US 2012/0197796 A1
(43) Pub. Date: Aug. 2, 2012

(54) CASH DISPENSING AT ATM

(76) Inventors: Nathan Dent, Charlotte, NC (US); Stephen R. Crowley, Huntersville, NC (US); Matthew Fairbairn, Huntersville, NC (US)

(21) Appl. No.: 13/017,754

(22) Filed: Jan. 31, 2011

(51) Int. Cl. G06Q 40/00

(52) U.S. Cl. 705/43

(57) ABSTRACT

Methods and apparatus according to the invention are directed towards providing apparatus for generating an emergency one time use (EOTU) personal identification number (PIN) for use at one or more automated teller machines. The apparatus may include a receiver configured to receive (1) information corresponding to an account holder at a financial institution and (2) information corresponding to a request from the account holder to electronically generate an EOTU PIN. The apparatus may also include a processor configured to (1) determine a maximum amount of funds to be accessed using the EOTU PIN and (2) electronically generate the EOTU PIN. The apparatus may additionally include a transmitter configured to electronically transmit to the account holder information relating to the EOTU PIN.

### FIELD OF TECHNOLOGY

This invention relates to an enhanced personal identification number (PIN). More specifically, this invention relates to an enhanced PIN for use at automated teller machines (ATMs).

### BACKGROUND OF THE INVENTION

An ATM session is typically activated when a customer swipes a bank card in an ATM card reader and enters an ATM PIN on an ATM keypad.

Typically, an ATM PIN offers a customer multiple ATM transaction options, e.g., DEPOSIT, WITHDRAW, FAST CASH, CHECK ACCOUNT BALANCE, etc. This list of choices does not provide a cardholder the ability to give a third party access to the cardholder's bank account. Rather, it focuses on a cardholder's access to his or her own accounts.

It would be desirable, therefore, to provide an ATM PIN that would establish an ATM session for a third party, preferably with limited transactional options.

Additionally, a cardholder is sometimes in a location where security or privacy are in question and desires to use his ATM card, yet not to expose the full scope of his accounts to possible trespass. The cardholder may be afraid of a criminal identifying his entered ATM PIN and stealing his ATM card, thereby obtaining full access to his accounts.

It is therefore desirable to provide an ATM PIN that would allow an ATM cardholder to withdraw a limited sum of money from his ATM card. Thus, in the event that his PIN is identified and his card is stolen, the criminal will have access to a limited amount of cardholder funds instead of a complete cardholder account balance.

Furthermore, a cardholder may lose his ATM card, for example, while traveling. Thus, it is desirable to provide systems and methods to enable a cardholder to access funds from an ATM prior to receiving a replacement ATM card.

### SUMMARY OF THE INVENTION

Methods and apparatus according to the invention are directed towards providing apparatus for generating an emergency one time use (EOTU) personal identification number (PIN) for use at one or more automated teller machines. The apparatus may include a receiver configured to receive (1) information corresponding to an account holder at a financial institution, and (2) information corresponding to a request from the account holder to electronically generate an EOTU PIN. The apparatus may also include a processor configured to (1) determine a maximum amount of funds to be accessed using the EOTU PIN and (2) electronically generate the EOTU PIN. The apparatus may additionally include a transmitter configured to electronically transmit to the account holder information relating to the EOTU PIN. The EOTU PIN generated using the methods and apparatus according to the invention may expire upon the lapse of a predetermined amount of time.

### BRIEF DESCRIPTION OF THE DRAWINGS

The objects and advantages of the invention will be apparent upon consideration of the following detailed description, taken in conjunction with the accompanying drawings, in which like reference characters refer to like parts throughout, and in which:

FIG. 1 shows apparatus that may be used in accordance with the principles of the invention;

FIG. 2 shows an apparatus for use according to the principles of the invention;

FIG. 3 shows a schematic diagram of another apparatus for use according to the principles of the invention;

FIG. 4 shows a schematic diagram of apparatus for use according to the principles of the invention;

FIG. 5 shows a schematic diagram of a network for use according to the principles of the invention;

FIG. 6 shows a schematic diagram of another apparatus for use according to the principles of the invention;

FIG. 7 shows elements of an illustrative hybrid device/process in accordance with the principles of the invention;

FIG. 8 shows a process in accordance with the systems and methods of the invention;

FIG. 9 shows an additional process in accordance with the systems and methods of the invention; and

FIG. 10 shows another process in accordance with the systems and methods of the invention.

### DETAILED DESCRIPTION OF THE DISCLOSURE

One Time Use Pin

An ATM session is typically activated when a customer swipes a bank card in an ATM card reader and enters an ATM PIN on an ATM keypad. Typically, an ATM PIN offers a customer multiple ATM transaction options, e.g., DEPOSIT, WITHDRAW, FAST CASH, CHECK ACCOUNT BALANCE, etc. This list of choices does not provide a cardholder the ability to give a third party access to the cardholder's bank account. Rather, it focuses on a cardholder's access to his or her own accounts.

The systems and methods of the invention include a one time use (“OTU”) PIN. The OTU PIN according to the systems and methods of the invention may enable an account holder to give a third party limited ATM access to one or more of his accounts.

Additionally, the OTU PIN may be used by the account holder himself. This is desirable in the event that the account holder is in a location where security or privacy are in question. Such an account holder may want only limited access to his account in case a shoulder-surfing criminal steals his bank card and uses his entered PIN.

The generation of the OTU PIN may be initiated by an account holder who owns one or more bank accounts, debit cards and/or credit cards at a financial institution. In some embodiments, an authorized user of the account holder's debit or credit card may also be authorized to initiate the generation of an OTU PIN. In additional embodiments, the generation of the OTU PIN according to the invention may be initiated by banking personnel on behalf of an account holder and/or authorized user.

The generation of the OTU PIN may be initiated via internet online banking (OLB), phone banking, a mobile phone application, an ATM self-service device and/or in person at a brick and mortar financial institution. It should be noted that in the event that a banking personnel assists an account holder to generate an OTU PIN, the OTU PIN may be sent to the account holder via short message service (SMS), text, e-mail or an automatically generated phone call. In the event that the OTU PIN is verbally communicated to the account holder, the OTU PIN may preferably have a shorter lifespan than an electronically transmitted OTU PIN.

The generation of the OTU PIN may include charging a fee to the account holder. The fee may be charged to the account holder when the OTU PIN is configured to be used by a user other than the account holder. In other embodiments, the fee may be charged for each generation of an OTU PIN.

The generated OTU PIN may be used solely at ATMs supported by the financial institution that facilitated generating the OTU PIN. In some embodiments, the OTU PIN may also be used at ATMs supported by financial institutions different from the financial institution that facilitated generating the OTU PIN.

In some embodiments of the invention, the OTU PIN may be configured to establish an ATM session. In other embodiments of the invention, the OTU PIN may be configured to establish an OLB session. It should be noted that the systems and methods of the invention described herein may be implemented at any suitable self service terminal such as a kiosk or other electronic device configured to enable a user to execute one or more banking transactions.

OTU Pin Configured to Establish an ATM Session

The creation of an OTU PIN configured to establish an ATM session may include displaying to the account holder, via a graphical user interface (GUI), multiple selectable parameters relating to the OTU PIN.

One or more of the multiple selectable parameters may be required parameters. A required parameter may be a parameter with which the account holder must execute a selection prior to the generation of the OTU PIN. The multiple selectable parameters may also include one or more optional parameters. An optional parameter may be a parameter with which the account holder is not required to execute a selection prior to the generation of the OTU PIN. In the event that the account holder does not execute a selection with respect to an optional parameter, the generation of the OTU PIN may include at least one default setting.

One or more of the selectable parameters displayed to the account holder may relate to account(s) that the OTU PIN affords access to during an ATM session. One or more of the selectable parameters may also relate to a predetermined time span and/or a predetermined number of ATM sessions during which the OTU PIN remains active. Furthermore, one or more of the selectable parameters may relate to a maximum amount of funds that the OTU PIN enables a user to withdraw during an ATM session. One or more of the selectable parameters may additionally relate to one or more ATM transactions that are displayed on an ATM screen flow upon initiation of an ATM session using the OTU PIN.

It should be noted that in the event that an account holder selects a maximum amount of funds that the OTU PIN enables a user to withdraw, the maximum amount of funds may be withdrawn from an account holder's bank account and transferred to a new account. These funds may be located in the new account until depleted or until the OTU PIN expires. Upon the expiration of the OTU PIN, any unused balance may be returned to the account holder's account from which the funds were originally withdrawn. Thus, these embodiments may increase the security of an OTU PIN transaction, since the account holder's account(s) are not accessed during an OTU PIN transaction.

In other embodiments, funds withdrawn using an OTU PIN may be withdrawn directly from an account holder's account.

In some embodiments of the invention, one or more of the selectable parameters may relate to restricting the usage of the OTU PIN to one or more ATMs. In additional embodiments, one or more of the selectable parameters may relate to restricting the usage of the OTU PIN to all ATMs located in one or more geographical locations. The geographical locations may be identified by selecting and/or entering information relating to one or more states, counties, zip codes and/or cities.

It should be noted that the selectable parameters may relate to any other additional information useful for the creation and/or maintenance of the OTU PIN.

The GUI displayed to the account holder during the initiation of the OTU PIN may additionally enable the account holder to identify one or more authorized users of the OTU PIN. For example, the GUI may display a selectable option enabling the account holder to identify himself as the authorized user of the OTU PIN. The GUI may additionally display a selectable option enabling the authorized user to identify one or more third parties as authorized users of the OTU PIN.

In some embodiments of the invention, a third party identified by the account holder as an authorized user of the OTU PIN may be required to be a customer of the financial institution facilitating the generation of the OTU PIN. In other embodiments, the authorized user may identify any third party as an authorized user of the OTU PIN.

In the embodiments in which one or more third parties have been identified as authorized users of the OTU PIN, the account holder may be required to enter information into one or more input fields. The information required to be entered into the one or more input fields may be user identification information that identifies one or more of the authorized users. At least some of the entered user identification information may be used by an ATM to verify that an OTU PIN user is an authorized OTU PIN user.

For example, in the event that an account holder selects to identify a third party as an authorized user of the OTU PIN, the GUI may subsequently display multiple input fields. The multiple input fields may require the account holder to enter information relating to one or more of the third party's name, home address, telephone number, e-mail address, postal code, height, eye color and/or biometric identification.

In some embodiments, the GUI may display one or more selectable parameters enabling the account holder to select the user identification that will be required for the authorized user(s) to identify themselves to an ATM. The GUI may additionally display the security risks associated with each of the selectable pieces of user identification. It should be noted that one or more pieces of user identification may be required by the financial institution.

In the event that the account holder executes a selection indicating the completion of the configuration of the OTU PIN, the GUI may subsequently initiate the generation of the OTU PIN. The OTU PIN may be generated using one or more processors. The one or more processors may use one or more algorithms to generate the OTU PIN. The algorithms may generate the OTU PIN based on the account holder's current PIN, a random number chosen by the authentication server and/or any other suitable method.

It should be noted that the OTU PIN may include numbers, letters and/or symbols, and may be any desirable length. Furthermore, the OTU PIN algorithm may enable the account holder to define the OTU PIN.

Upon generation of the OTU PIN, the account holder may receive a message including the OTU PIN via e-mail, short message service (SMS), text message, an automated phone call and/or any other suitable method. In the embodiments in which the account holder has selected one or more authorized users, the OTU PIN may be sent to the authorized user(s) and/or the account holder. It should be noted that the transmittal of the OTU PIN may include information relating to the usage of the OTU PIN, the duration of the OTU PIN, user identification necessary to identify oneself to an ATM and/or any other suitable information.

Following the generation of the OTU PIN, information relating to the OTU PIN may be stored in a central server. In some embodiments, the information relating to the OTU PIN may be stored in the central server in an encrypted form. Additionally, information relating to the parameters associated with the OTU PIN and/or any other suitable information may be stored in the central server. In some embodiments, this information may also be stored in encrypted form in the central server. The central server may be accessible at least to all ATMs configured to initiate an ATM session based at least in part on the OTU PIN.

In the event that the account holder selects one or more ATMs at which the OTU PIN must be used, a workload containing the OTU PIN and related information may be transmitted to the one or more selected ATMs. In some embodiments, at least part of the transmitted information may be transmitted in encrypted form.

In the event that the account holder selects one or more geographical locations within which the OTU PIN must be used, a workload containing the OTU PIN and related information may be sent to all ATMS in the one or more selected geographical locations. In these embodiments, the workload may be read and stored solely by the ATMs to which it was sent. This may increase the security of the OTU PIN at least because information relating to the OTU PIN is solely readable by one or more ATMs and not stored on a centralized ATM server. It should be noted that in some of these embodiments, at least part of the transmitted information may be transmitted in encrypted form.

An authorized user of the OTU PIN may desire to initiate an ATM session using the OTU PIN. The authorized user may be required to enter the OTU PIN at an ATM keypad. In some embodiments, the authorized user may also be required to enter one or more pieces of user identification.

It should be noted that the ATM may first request the authorized user to input the OTU PIN in the ATM. The ATM may subsequently determine if the entered OTU PIN requires the authorized user to enter one or more pieces of user identification prior to the initialization of an ATM session. In the event that the ATM determines that the entered OTU PIN does require the user to enter one or more pieces of user identification, the ATM may simultaneously thereto or subsequently thereafter display one or more user input fields prompting the user to enter the one or more pieces of user identification.

For example, an authorized user of an OTU PIN may desire to establish an ATM session using the OTU PIN. The authorized user may select an option “ENTER OTU PIN” on an initial ATM screen flow. The ATM may subsequently display an input field for the user to enter the OTU PIN. In the embodiments in which an OTU PIN may contain letters and/or characters, the ATM may additionally display selectable letters and/or characters. When the authorized user finishes entering his OTU PIN, the ATM may subsequently determine that the entered OTU PIN requires the user to identify himself by name, address and phone number. The ATM may then display an ATM screen flow including input fields: NAME, ADDRESS and PHONE NUMBER. When the authorized user finishes entering the requested information, he may select a FINISHED icon included on the displayed GUI. Upon receipt of information relating to the selection of the FINISHED icon, the ATM may subsequently determine if the entered information adequately identifies an authorized user of the OTU PIN.

Exemplary user identification that may be required to be entered into the user input fields may include one or more of a user name, home address, telephone number, e-mail address, postal code, height, eye color and/or any other suitable information. Additionally, the user may be required to swipe in an ATM card reader a user bank card, a user credit card and/or a user license. Furthermore, the user may be required to enter one or more pieces of biometric identification into an ATM biometric sensor. It should be noted that some embodiments may offer the authorized user the option of entering user identification in one or more user input fields that may be selected from multiple user input fields.

User identification input in the ATM may be required to include information substantially similar to one or more pieces of user identification identified by the account holder during the creation of the OTU PIN. In the event that the ATM determines that the input user identification is substantially identical to user identification identified by the account holder during the creation of the OTU PIN, the ATM may determine that the OTU PIN user is an authorized OTU PIN user.

In an exemplary embodiment, an authorized user of an OTU PIN may be required to swipe a debit or credit card in the ATM card reader prior to the establishment of an ATM session. The debit or credit card may not be required to be a debit or credit card supplied by the financial institution supporting the ATM. The ATM may extract information from the swiped card corresponding to the user's full name or some other suitable aspect of the user information stored on the swiped card. In the event that the ATM determines that the extracted information is substantially identical to a user name or other user information identified by the account holder, the ATM may determine that the user of the OTU PIN is an OTU PIN authorized user.

The ATM may verify the OTU PIN and the customer identification using one or more algorithms and/or stored information. Alternately, the ATM may verify the OTU PIN and the customer identification by sending information corresponding to the OTU PIN and the customer identification to a third party. The third party may be any desirable interbank network, banking system, software application and/or authorization system. In some embodiments, the ATM may initially transmit the information to an ATM Controller (ATMC) which may subsequently route the financial information to the third party. It should be noted that in some embodiments, at least part of the transmitted information may be transmitted in encrypted form.

The third party may verify the OTU PIN and the customer identification. In the event that the third party determines that the OTU PIN is valid and that the customer identification properly identifies an authorized user of the OTU PIN, the third party may instruct the ATM regarding the parameters of the ATM session that the entered OTU PIN is authorized to establish.

Upon initiation of an ATM session, the ATM session may be constrained according to one or more parameters selected by the account holder during the initiation of the OTU PIN. In the event that the account holder did not select any parameters restricting the permissions of the authorized user(s), the initiated ATM session may be substantially identical to a generic ATM session that the account holder would initiate using his ATM PIN and card.

In some embodiments, upon completion of an ATM session established using an OTU PIN, the ATM may display and/or print a receipt showing a remaining amount of funds available to be withdrawn with the OTU PIN. The remaining balance of funds available to be withdrawn using the OTU PIN may be less than the account holder's account balance. This is desirable at least when using an ATM in a location where security or privacy are in question, since it would inform a shoulder-surfing criminal that the ATM card is not worth stealing due to the displayed, and printed, low account balance.

After the execution of an ATM session using an OTU PIN, an electronic message may be transmitted to the account holder via e-mail, SMS or text. The message may state that the OTU PIN was used. The message may additionally state the time at which the OTU PIN was used, the location at which the OTU PIN was used, how much money was withdrawn, which transactions were executed and/or any other relevant information.

It should be noted that during the initiation of the OTU PIN, one or more of the selectable parameters may relate to one or more predetermined occurrences that will initiate the transmission of an electronic notification to the account holder. For example, an account holder may desire to generate an OTU PIN for his teenage daughter. This account holder may request an electronic notification, e.g. via e-mail, in the event that the OTU PIN is used in a geographical location associated with establishments offering alcohol.

An electronic message may also be transmitted to the account holder upon the expiration of the OTU PIN. In the event that the amount of funds available to be withdrawn using the OTU PIN has not been fully depleted, the message may state the unused balance.

It should be noted that upon deactivation of the OTU PIN, the account holder may reactivate an OTU PIN with the same or different parameters that were applied to the previous OTU PIN. The re-activated OTU PIN may contain the same numerical sequence as the previous OTU PIN. In other embodiments, the re-activated OTU PIN may be different from the previous OTU PIN.

It should additionally be noted that in certain embodiments, the user may store a set of OTU PIN parameters that may be accessed with a user selection. These embodiments may enable the user not to have to re-enter all of his OTU PIN parameters each time he wishes to create an OTU PIN.

OTU PIN Configured to Establish an Online Banking Session

The creation of an OTU PIN configured to establish an OLB session may include displaying to the account holder, via a GUI, multiple selectable parameters relating to the OTU PIN. It should be noted that in the embodiments in which the account holder desires to create the OTU PIN using phone banking and/or at a brick and mortar financial institution, these multiple selectable parameters may be verbally communicated to the account holder. It should additionally be noted that one or more of the multiple selectable parameters may be required and/or optional parameters.

One or more of the selectable parameters displayed to the account holder may relate to a predetermined time span during which the PIN will remain active and/or the account(s) that the OTU PIN will provide access to. Additionally, one or more of the selectable parameters may relate to a maximum amount of funds that the OTU PIN may authorize for a transfer between accounts or out of one or more accounts. Furthermore, one or more of the selectable parameters may relate to a maximum amount of funds that the OTU PIN may authorize to pay bills via online bill pay and/or for executing electronic transactions and/or wires. It should be noted that the selectable parameters may additionally relate to any other information useful for the creation and/or maintenance of the OTU PIN.

The GUI displayed to the account holder during the initiation of the OTU PIN may also enable the account holder to identify one or more authorized users. The account holder may be required to provide one or more pieces of information identifying the one or more authorized users into one or more input fields. For example, the account holder may be required to enter in one or more input fields information relating to an authorized user name, address, telephone number, postal code, personal bank card information and/or any other suitable information.

In the event that the account holder executes a selection indicating the completion of the configuration of the OTU PIN, the GUI may subsequently initiate the generation of the OTU PIN using one or more processors. The processors may use one or more mathematical algorithms to generate the OTU PIN. The generated OTU PIN may include numbers, letters and/or symbols, and may be any desirable length. Furthermore, the OTU PIN algorithm may enable the account holder to define the OTU PIN.

After the generation of the OTU PIN, the account holder may receive an electronic message including the OTU PIN via e-mail, short message service (SMS), text message, automated phone call and/or any other suitable method. In the embodiments in which the account holder has selected one or more authorized users, the OTU PIN may be transmitted to the authorized user(s) and/or the account holder. It should be noted that the transmittal of the OTU PIN may include information relating to the usage of the OTU PIN, the duration of the OTU PIN, and any other suitable information.

After the generation of the OTU PIN, information relating to the OTU PIN, parameters associated with the OTU PIN and/or any other suitable information may be stored in a database. The database may be accessible to the OLB portal. It should be noted that in some embodiments, at least part of the stored information may be stored in encrypted form.

In the event that a user desires to initiate an OLB session using an OTU PIN, the user may be required to enter the OTU PIN. In some embodiments, the user may also be required to enter one or more pieces of user identification.

The portal may determine if the OTU PIN is a valid PIN by querying the database that stores the information relating to the OTU PIN. In the event that the user entered one or more pieces of user identification, the portal may additionally query the database to determine if the entered user identification is substantially identical to user identification information entered by the authorized user. In the event that the OTU PIN is determined to be valid and the entered user identification is substantially identical to the user identification identified by the authorized user, the portal may initiate an OLB session.

The OLB session may be restricted by one or more parameters selected by the account holder during the creation of the OTU PIN. In the event that the account holder did not select any restricting parameters, the initiated OLB session may be a generic OLB session.

Upon completion of the OLB session, a message may be electronically sent to the account holder via e-mail, SMS, or text stating that the PIN was used. The message may additionally state the time that the OTU PIN was used, how much money was used to pay bills, what transfers were executed and/or any other relevant information.

It should be noted that one or more of the systems and methods included in the embodiments in which the OTU PIN is configured to establish an ATM session may be included in the embodiments in which the OTU PIN is configured to establish an OLB session.

Emergency Cash

A cardholder may lose his ATM card while traveling. Thus, it is desirable to provide systems and methods to enable a cardholder to access funds from an ATM prior to receiving a replacement ATM card.

The systems and methods of the invention may include an emergency OTU PIN (referred to alternately hereinafter as “EOTU PIN”). The EOTU PIN may be generated in the event that a cardholder loses his ATM card, for example, while travelling. The EOTU PIN may enable the cardholder to withdraw funds from an ATM without his ATM card. Thus, these systems and methods may enable a financial institution to disburse emergency funds to a distressed cardholder prior to his receipt of a replacement ATM card.

In some embodiments of the invention, a cardholder may initiate the generation of an EOTU PIN by calling a telephone banking number and speaking to a customer representative or by dialing into an automated phone service. The customer representative may verify the cardholder's identity using questions that the cardholder can answer without access to his lost ATM card.

Upon verification of the cardholder's identity, the customer representative may cancel the cardholder's lost card(s). The customer representative may also order the shipment of one or more replacement ATM cards. The customer representative may additionally offer the cardholder the option of creating an EOTU PIN in accordance with the systems and methods of the invention.

In the event that the cardholder desires to create an EOTU PIN, the customer representative may ask the cardholder to specify an amount of funds that he desires to access with the EOTU PIN. The customer representative may additionally inform the customer that the amount of funds that he may access using the EOTU PIN may be limited by a maximum amount. The maximum amount may be determined by a computer program which the customer representative may access. The computer program may base this determination at least in part on a cardholder risk profile, cardholder account balance(s), cardholder credit rating, cardholder need and/or any other relevant information.

In the event that the cardholder desires to initiate the creation of the EOTU PIN and agrees to an ATM withdrawal amount and associated terms and conditions, the EOTU PIN may be automatically generated using one or more algorithms. The EOTU PIN may include numbers, letters and/or characters, and may be any suitable length.

Upon generation of the EOTU PIN, the EOTU PIN may be preferably transmitted to the cardholder via e-mail, SMS, text message and/or an automatically generated phone call. Thus, in these embodiments, the customer representative may have no knowledge of the generated EOTU PIN. In some embodiments, the generated EOTU PIN may be active for a limited amount of time prior to expiration.

In the event that the cardholder is unable to receive an electronically generated message including the EOTU PIN, the customer representative may verbally communicate the EOTU PIN to the cardholder. For security purposes, a verbally communicated EOTU PIN may be active for a shorter time span than an electronically issued EOTU PIN.

It should be noted that in some embodiments of the invention, the ATM cardholder may create an EOTU PIN using an OLB portal. In these embodiments, the OLB portal may include one or more pages dedicated to the creation of the EOTU PIN. The cardholder may select an amount of funds that he desires to access using the EOTU PIN. The amount of funds may be limited by a maximum amount. In the event that the cardholder indicates that he desires to create the EOTU PIN, the EOTU PIN may be automatically generated and transmitted to him electronically.

In certain embodiments, the user may store a set of default OTU PIN parameters that may be accessed with a user selection. These embodiments may enable the user not to have to re-enter all of his OTU PIN parameters each time he wishes to create an OTU PIN.

The cardholder may use the EOTU PIN at one or more ATMs supported by the financial institution that created the EOTU PIN. In some embodiments, the cardholder may use the EOTU PIN at any ATM in a predetermined location. In other embodiments, the EOTU PIN may be used at a point of sale (“POS”) terminal to pay for purchased goods. In further embodiments, the financial institution may authorize a transfer of credits to the cardholder, or a designated third party, using a smartphone for utilization via Near Field Communications (NFC) terminals.

It should be noted that geographical limitations used in the OTU PIN embodiments may also be applied to one or more of the EOTU PIN embodiments. Furthermore, any additional systems and methods included in the OTU PIN embodiments may also be applied to one or more of the EOTU PIN embodiments.

In the event that the EOTU PIN has been used, an automated e-mail, SMS or text message may be sent to the cardholder to notify him of the transaction.

Additional Security for ATM Transactions

The systems and methods of the invention may also include an additional level of security for bank card authorizations. In these embodiments, an ATM user may swipe his ATM bank card at an ATM to initiate an ATM session. After swiping his card, the ATM may send to the user's cell phone, via text message, e-mail or SMS, an OTU PIN. The user may then be required to enter the OTU PIN in an ATM keypad and/or ATM touch screen to authenticate the ATM session. In other embodiments, the user may be required to enter the OTU PIN in addition to his standard PIN to initiate the ATM session.

These systems and methods may be used in the event that a user attempts to initiate an ATM session at an ATM infrequently used by the user, in the event that the ATM is in one or more predetermined locations that may be associated with ATM fraud and/or in any other desirable embodiment(s).

In additional embodiments of the invention, a user may initiate an ATM session using his standard PIN and execute a selection to initiate a high risk transaction. The ATM may subsequently halt the transaction and electronically transmit to the user's phone an OTU PIN. In these embodiments, the ATM may initiate the selected transaction only when the user enters the transmitted OTU PIN in an ATM keypad and/or ATM touch screen.

In these additional embodiments, a high risk transaction may be a transaction that involves the withdrawal or deposit of a sum of money greater than a threshold amount, a transaction infrequently selected by the user and/or any other suitable transaction. It should be noted that the determination of a high risk transaction may be based at least in part on a user account balance, historical ATM user behavior, user credit history, etc.

Illustrative embodiments of apparatus and methods in accordance with the principles of the invention will now be described with reference to the accompanying drawings, which form a part hereof. It is to be understood that other embodiments may be utilized and structural, functional and procedural modifications may be made without departing from the scope and spirit of the present invention.

As will be appreciated by one of skill in the art, the invention described herein may be embodied in whole or in part as a method, a data processing system, or a computer program product. Accordingly, the invention may take the form of an entirely hardware embodiment, an entirely software embodiment or an embodiment combining software, hardware and any other suitable approach or apparatus.

Furthermore, such aspects may take the form of a computer program product stored by one or more computer-readable storage media having computer-readable program code, or instructions, embodied in or on the storage media. Any suitable computer readable storage media may be utilized, including hard disks, CD-ROMs, optical storage devices, magnetic storage devices, and/or any combination thereof. In addition, various signals representing data or events as described herein may be transferred between a source and a destination in the form of electromagnetic waves traveling through signal-conducting media such as metal wires, optical fibers, and/or wireless transmission media (e.g., air and/or space).

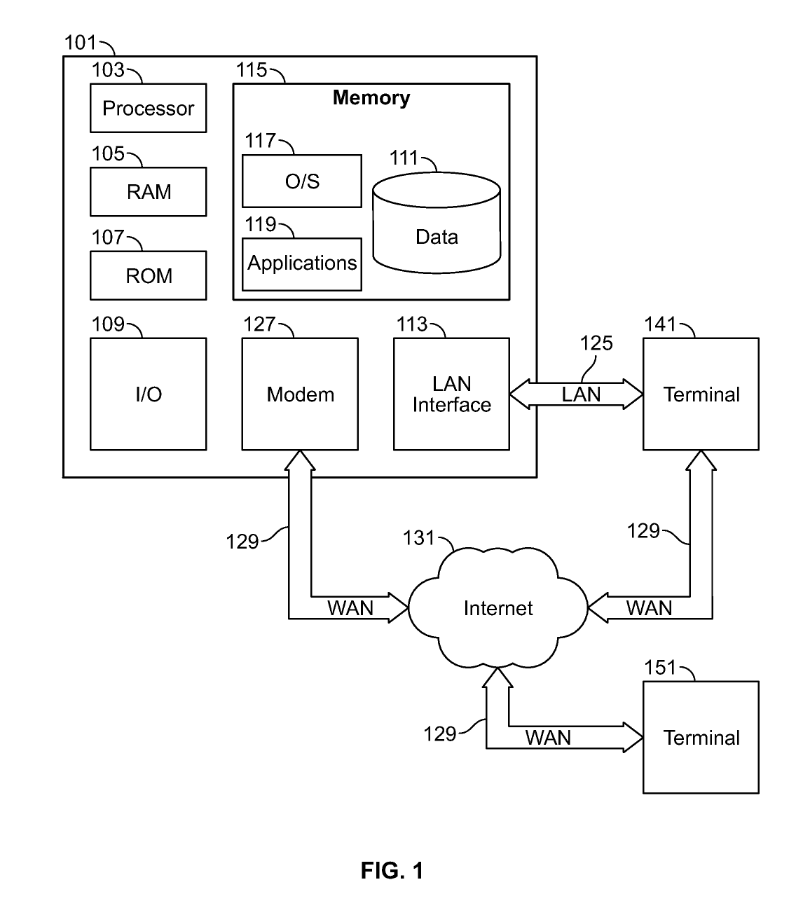

FIG. 1 is a block diagram that illustrates a generic computing device 101 (alternatively referred to herein as a “server”) that may be used according to an illustrative embodiment of the invention. The computer server 101 may have a processor 103 for controlling overall operation of the server and its associated components, including RAM 105, ROM 107, input/output module 109, and memory 115.

Input/output (“I/O”) module 109 may include a microphone, keypad, touch screen, and/or stylus through which a user of device 101 may provide input, and may also include one or more of a speaker for providing audio output and a video display device for providing textual, audiovisual and/or graphical output. Software may be stored within memory 115 and/or storage to provide instructions to processor 103 for enabling server 101 to perform various functions. For example, memory 115 may store software used by server 101, such as an operating system 117, application programs 119, and an associated database 111. Alternatively, some or all of server 101 computer executable instructions may be embodied in hardware or firmware (not shown).

Server 101 may operate in a networked environment supporting connections to one or more remote computers, such as terminals 141 and 151. Terminals 141 and 151 may be personal computers or servers that include many or all of the elements described above relative to server 101. The network connections depicted in FIG. 1 include a local area network (LAN) 125 and a wide area network (WAN) 129, but may also include other networks. When used in a LAN networking environment, computer 101 is connected to LAN 125 through a network interface or adapter 113. When used in a WAN networking environment, server 101 may include a modem 127 or other means for establishing communications over WAN 129, such as Internet 131. It will be appreciated that the network connections shown are illustrative and other means of establishing a communications link between the computers may be used. The existence of any of various well-known protocols such as TCP/IP, Ethernet, FTP, HTTP and the like is presumed, and the system can be operated in a client-server configuration to permit a user to retrieve web pages from a web-based server. Any of various conventional web browsers can be used to display and manipulate data on web pages.

Additionally, application program 119, which may be used by server 101, may include computer executable instructions for invoking user functionality related to communication, such as email, short message service (SMS), and voice input and speech recognition applications.

Computing device 101 and/or terminals 141 or 151 may also be mobile terminals including various other components, such as a battery, speaker, and antennas (not shown).

Terminal 151 and/or terminal 141 may be portable devices such as a laptop, cell phone, Blackberry™, or any other suitable device for storing, transmitting and/or transporting relevant information.

Any information described above in connection with database 111, and any other suitable information, may be stored in memory 115.

One or more of applications 119 may include one or more algorithms that may be used to generate one or more OTU PINs in accordance with the systems and methods of the invention.

The invention may be operational with numerous other general purpose or special purpose computing system environments or configurations. Examples of well known computing systems, environments, and/or configurations that may be suitable for use with the invention include, but are not limited to, personal computers, server computers, hand-held or laptop devices, mobile phones and/or other personal digital assistants (“PDAs”), multiprocessor systems, microprocessor-based systems, set top boxes, programmable consumer electronics, network PCs, minicomputers, mainframe computers, distributed computing environments that include any of the above systems or devices, and the like.

The invention may be described in the general context of computer-executable instructions, such as program modules, being executed by a computer. Generally, program modules include routines, programs, objects, components, data structures, etc. that perform particular tasks or implement particular abstract data types. The invention may also be practiced in distributed computing environments where tasks are performed by remote processing devices that are linked through a communications network. In a distributed computing environment, program modules may be located in both local and remote computer storage media including memory storage devices.

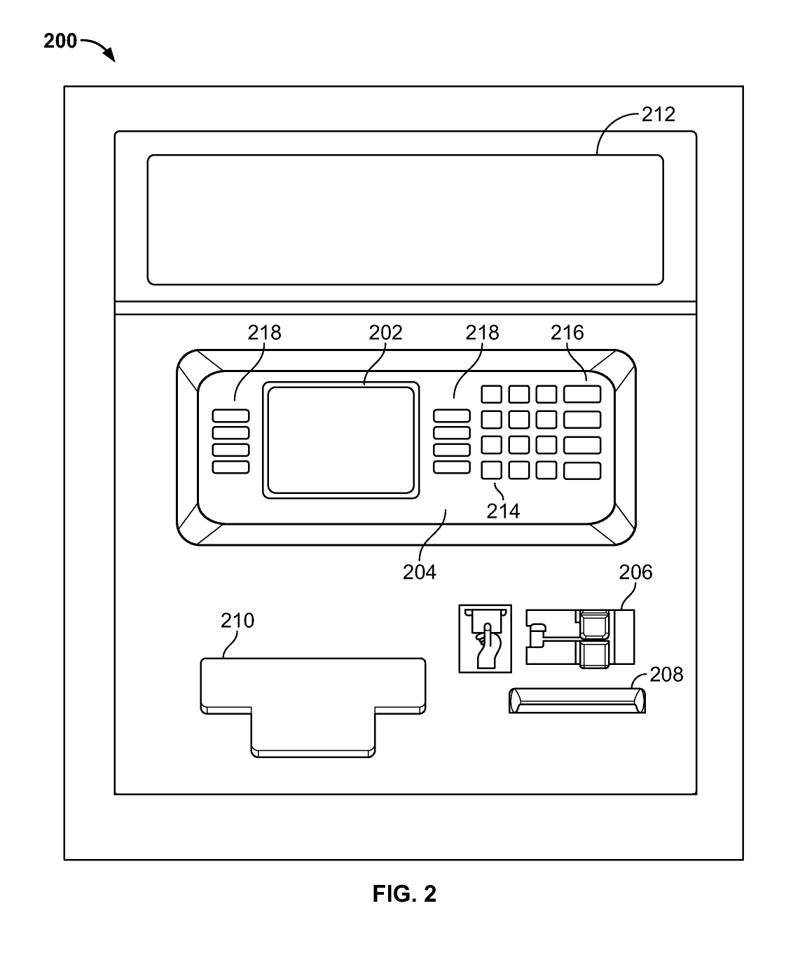

FIG. 2 shows illustrative self-service device 200, which may be an ATM. Self-service device 200 may include monitor 202, keypad 204, card reader port 206, document acceptor 208, item dispenser 210 and security screen 212.

Monitor 202 may exchange visual and or audio information with a customer. In some embodiments, monitor 202 may include a touch screen device that permits user input and/or selection. Keypad 204 may include alphanumeric keys 214 for the customer to enter numerical and textual data. Keypad 204 may include control keys 216. In some embodiments, control keys 216 may be used to communicate control information, such as instructions, to self-service device 200. Keypad 204 may include soft keys. Soft keys 218 may have functions that are dictated by programming and are presented to the customer using information that may be displayed on monitor 202.

Card reader port 206 may be the front end of any suitable card reader. The card reader may read magnetically encoded information on transaction instruments such as bank cards. In some embodiments, self-service device 200 may include a contactless chip reader, a wireless transceiver or any other suitable interface for exchanging transaction information with a transaction instrument. The transaction instrument may be a chip, an RFID tag, a smart card, a PDA, a telephone or any other suitable device.

In some embodiments, self-service device 200 may include a biometric sensor (not shown). The biometric sensor may identify a customer based on a feature, such as an anatomical feature, of the customer. For example, the biometric sensor may be configured to identify the customer based on all or part of a face, a fingerprint, an iris, a retina a hand or any other suitable anatomical feature. The biometric sensor may identify the customer based on a behavioral feature such as a signature, a voice, a gait or any other suitable behavioral feature.

Document acceptor 208 may accept any suitable documents. For example, document acceptor 208 may accept envelopes, deposit forms, bills, checks or any other suitable documents. In some embodiments, document acceptor 208 may feed into a scanner that digitizes the documents for image-based transaction processing.

It should be noted that an OTU PIN according to the invention may or may not limit the ability of a user to deposit documents in self-service device 200. In certain embodiments, an OTU PIN may limit certain types of document deposits but not others. In other embodiments, an OTU PIN may prevent any deposits in self-service device 200.

Item dispenser 210 may dispense items. For example, item dispenser 210 may dispense bills. In some embodiments of the invention, dispenser 210 may be limited to dispensing certain amounts of funds, and/or certain sizes of bills.

Security screen 212 may visually screen a surveillance device (not shown). The surveillance device may provide video information about individuals that are present near the self-service device and the conditions there.

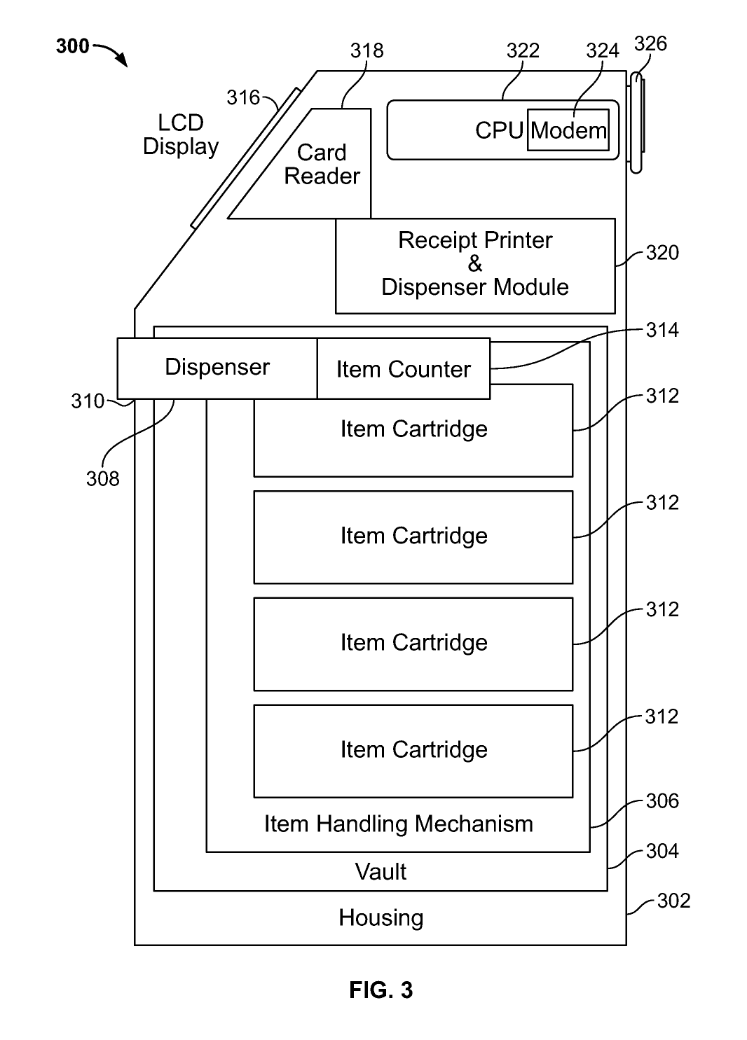

FIG. 3 shows illustrative self-service device 300. Self-service device 300 may have one or more of the features of self-service device 200 (shown in FIG. 2). Self-service device 300 may include housing 302. Self-service device 300 may include vault 304. Vault 304 may contain items (not shown). Item handling mechanism 306 may be present in vault 304. Item handling mechanism 306 may store, arrange, dispense and/or otherwise handle items for dispensing from self-service device 200. For example, item handling mechanism 306 may include conveyors (not shown) for positioning and repositioning items for dispensing by dispenser 308 through item port 310. Items (not shown) in item handling mechanism 306 may be contained in item cartridges 312. For example, when the items are bills, item cartridges 312 may be cash cartridges.

Item handling mechanism 306 may include item counter 314. Item counter 314 may count items prior to dispensing by dispenser 308.

Self-service device 300 may include LCD display 316 and a keypad (not shown) for customer interaction. In some embodiments, self-service device may also include a touch screen device that permits user input and/or selection. Card reader 318 may be present for receiving transaction information from the customer via a suitable transaction instrument. Self-service device 300 may include receipt printer and dispenser module 320. Receipt printer and dispenser module 320 may provide the customer with a record of a transaction. CPU 322 may control customer I/O, dispensing processes, which may include initialization, actuation, dispensing and any other suitable processes, receipt printing and dispensing, transaction channel communications and any other suitable processes. The transaction channel communications may be performed using modem 324, which may be any suitable communication device. Modem 324 may communicate with a local or regional network router (not shown). Service monitor 326 may be provided for a service technician to exchange information and instructions with CPU 322.

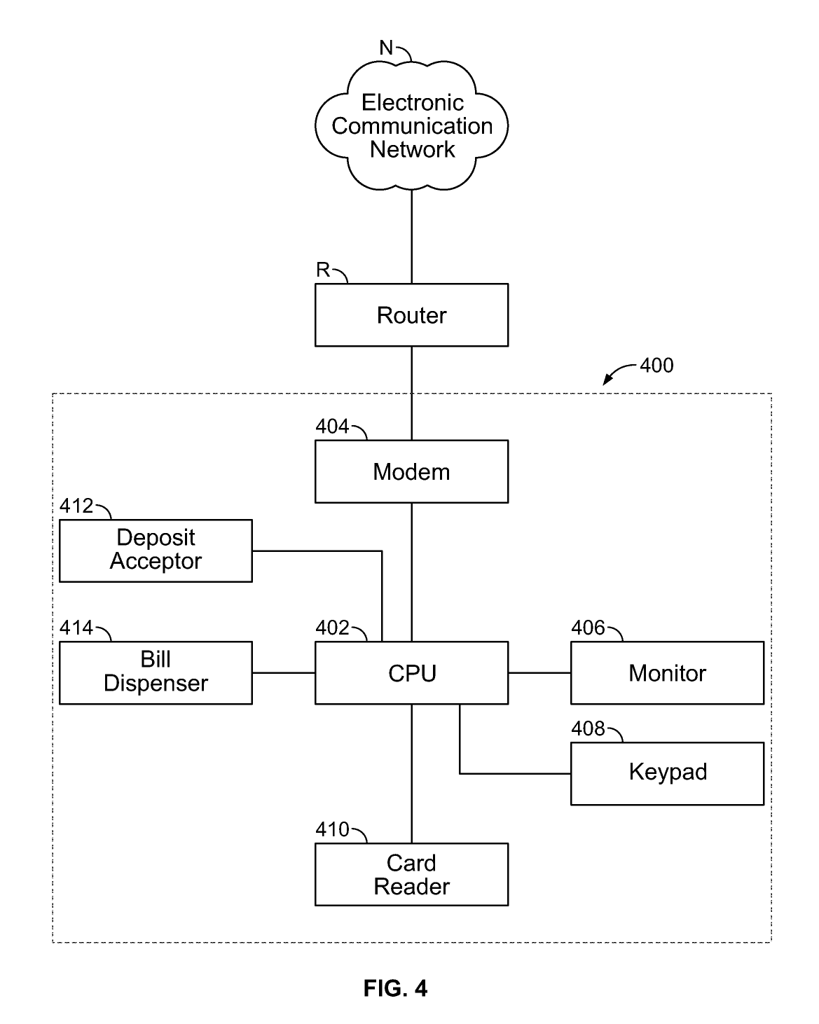

FIG. 4 shows control system 400 for controlling a self-service device such as 300 (shown in FIG. 3). System 400 is controlled by CPU 402. CPU 402 exchanges transaction information with electronic communication network N via modem 404, which is in communication with router R. CPU 402 may receive transaction information from a customer via monitor 406, keypad 408, card reader 410 and deposit acceptor 412. CPU 402 may dispense bills through bill dispenser 414.

In certain embodiments of the invention, CPU 402 may receive transaction information from keypad 408 and/or card reader 410 that corresponds to an OTU PIN according to the invention. In such circumstances, CPU 402 may preferably communicate such information to network N via modem 404, which is in communication with router R. It should be noted that in some embodiments, at least some of the communicated information may be in encrypted form.

In some embodiments of the invention, a CPU, such as CPU 402 may be in communication with a memory (not shown) on the self-service device 400. Such a memory may store information relating to a numerical sequence of an OTU PIN and additional OTU PIN information.

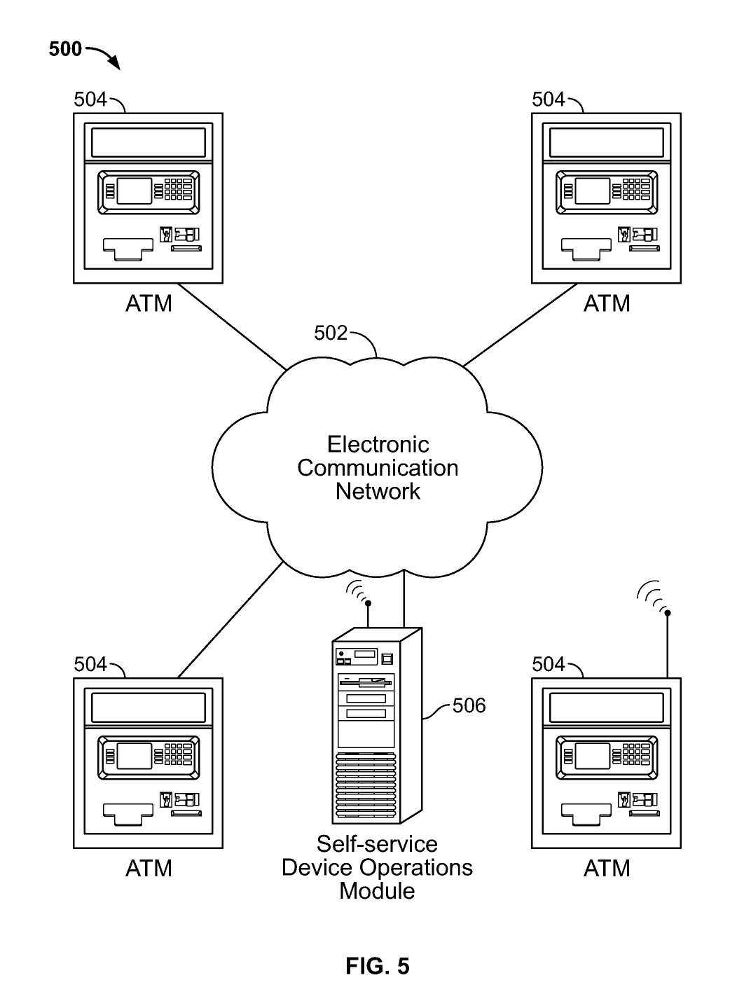

FIG. 5 shows illustrative transaction information network 500. Transaction information network 500 may include electronic communication network 502. Network 502 may be in part a LAN or WLAN, a WAN or WLAN or any other suitable network. Network 502 or portions thereof may be cabled, wired, optical fibered or wireless.

Self-service devices such as ATMs 504 may communicate via electronic communication network 502 with self-service device operations module 506. Self-service device operations module 506 may include one or more devices shown in FIG. 1. A remote user may use self-service device operations module 506 to monitor, control and/or intervene in one or more processes of ATMs 504. Such actions may correspond to one or more of the various OTU PIN embodiments and/or any other relevant embodiments described herein.

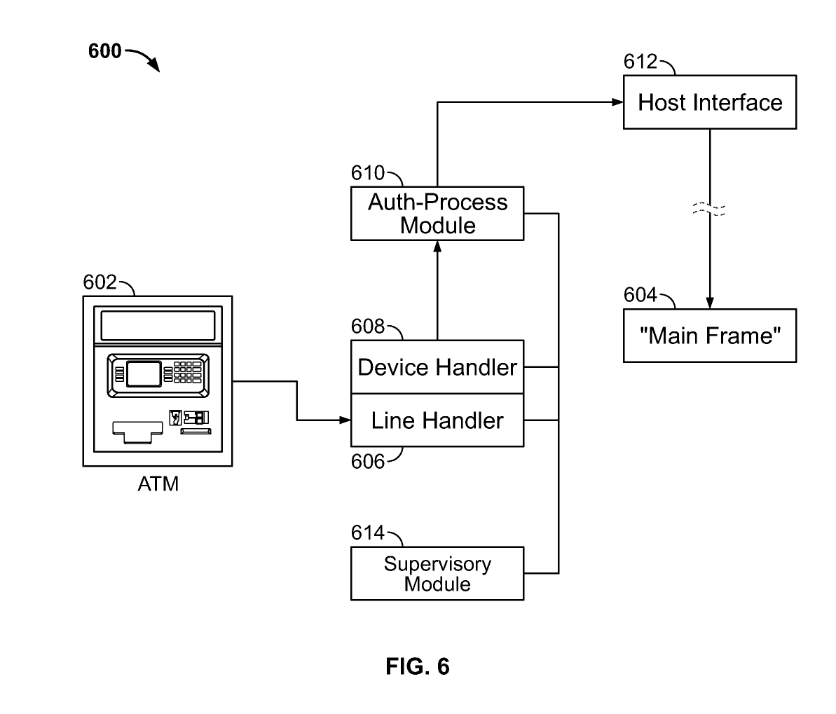

FIG. 6 shows illustrative portions of communication system 600 for exchanging transaction information between ATM 602 and financial institution transactional platform 604. ATM 602 may be an ATM such as 300 (shown in FIG. 3). Transactional platform 604 may be any suitable device for settlement and clearing of transactions. For example, platform 604 may be a financial institution mainframe.

Command lines in transactional information from ATM 602 may be executed at line handler protocol layer 606. Device handler 608 may handle routing decisions based on transactional information requirements for authorization, settlement, clearance, transactional networks and issuing financial institutions.

In certain implementations according to the invention, such authorization may include OTU PIN authorization. Such OTU PIN authorization may also be executed at line handler protocol layer 606.

Authorization requests may then be processed by auth-process module 610. Auth-process module 610 may then provide transactional information to host interface 612 for communication with platform 604. In OTU PIN embodiments according to the invention, such transaction information may be further processed by host interface 612 and communicated to main frame 604.

Supervisory module 614 may receive diagnostic data from line handler 606, device handler 608, auth-process module 610, or any other suitable source. The diagnostic data may be used to manage ATM 602. The diagnostic data may be provided to a self-service operations module such as 506 (shown in FIG. 5).

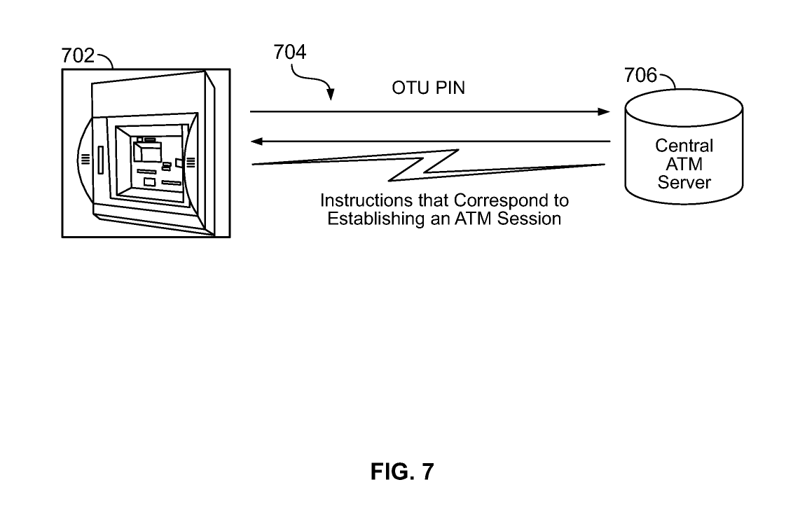

FIG. 7 shows elements of an illustrative hybrid device/process in accordance with the principles of the invention. FIG. 7 shows ATM 702. The network accessibility 704 of ATM 702 may require a secure network connection. Such network accessibility 704 may provide a connection to Central ATM Server 706. Such accessibility, together with ATM data transmission, may preferably be used to implement one or more OTU PIN embodiments.

Information relating to an OTU PIN entered in an ATM keypad included in ATM 702 may be transferred to Central ATM Server 706. Central ATM Server 706 may query a database to determine if the information relating to the OTU PIN corresponds to a valid OTU PIN. In some embodiments, information relating to user identification may be entered in an ATM keypad, GUI and/or ATM card reader included in ATM 702. The information relating to the user identification may also be transferred to Central ATM Server 706. In these embodiments, Central ATM Server 706 may query the database to determine if the information relating to the user identification sufficiently identifies an authorized user of the OTU PIN. In the event that Central ATM Server 706 determines that the OTU PIN information corresponds to a valid OTU PIN and the user identification sufficiently identifies an authorized user of the OTU PIN, Central ATM Server 706 may transmit instructions to ATM 702 that correspond to establishing an ATM session.

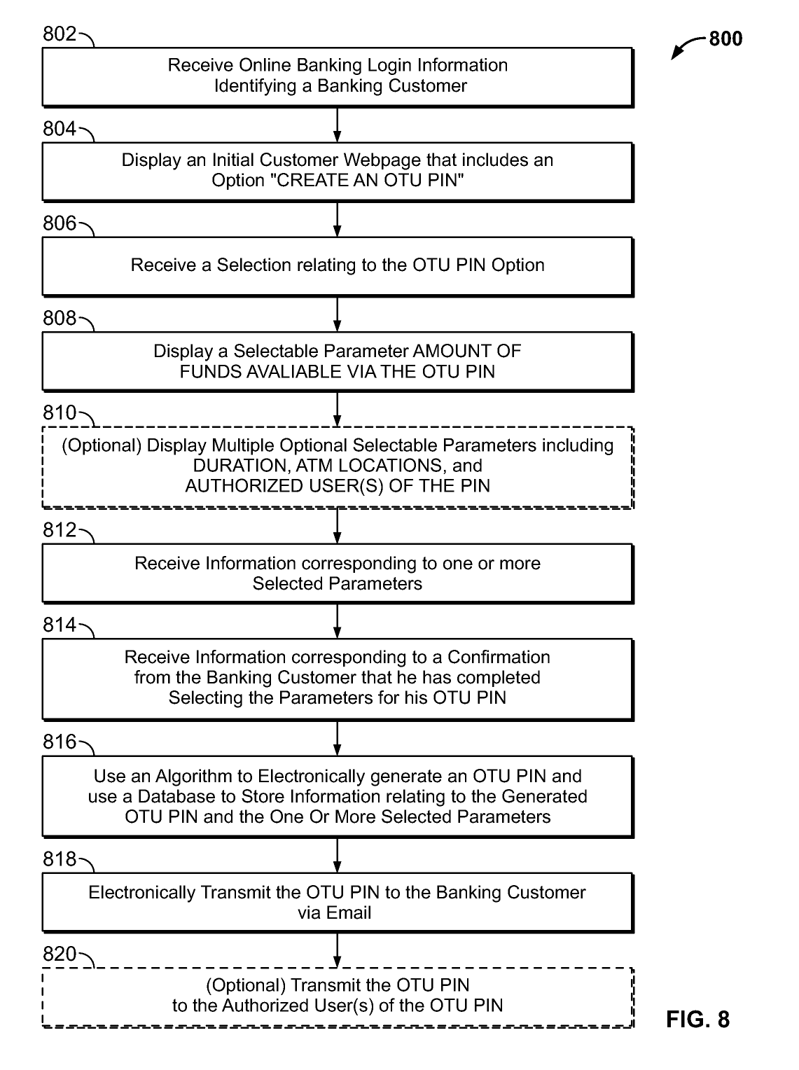

FIG. 8 illustrates exemplary process 800 in accordance with systems and methods of the invention. Process 800 may begin at step 802. At step 802, an online banking (OLB) portal may receive online banking login information identifying a banking customer. At step 804, the OLB portal may display an initial customer webpage that includes an option “CREATE AN OTU PIN.” At step 806, the OLB portal may receive a selection relating to the OTU PIN option. The OLB portal may display a selectable parameter AMOUNT OF FUNDS AVAILABLE VIA THE OTU PIN at step 808. Process 800 may optionally included step 810. At step 810, the OLB portal may display multiple optional selectable parameters including DURATION, ATM LOCATIONS and AUTHORIZED USER(S) OF THE PIN. At step 812, the OLB portal may receive information corresponding to one or more selected parameters. At step 814, the OLB portal may receive information corresponding to a confirmation from the banking customer that he has completed selecting parameters for his OTU PIN.

Process 800 may continue at step 816. At step 816, the OLB portal may use an algorithm to electronically generate an OTU PIN. Additionally, at step 816, the OLB portal may use a database to store information relating to the generated OTU PIN and the one or more selected parameters. It should be noted that in some embodiments, at least part of the stored information may be stored in encrypted form. At step 818, the OLB portal may electronically transmit the OTU PIN to the banking customer via email. Step 820 may optionally be included in process 800. At step 820, the OLB portal may transmit the OTU PIN to the authorized user(s) of the OTU PIN.

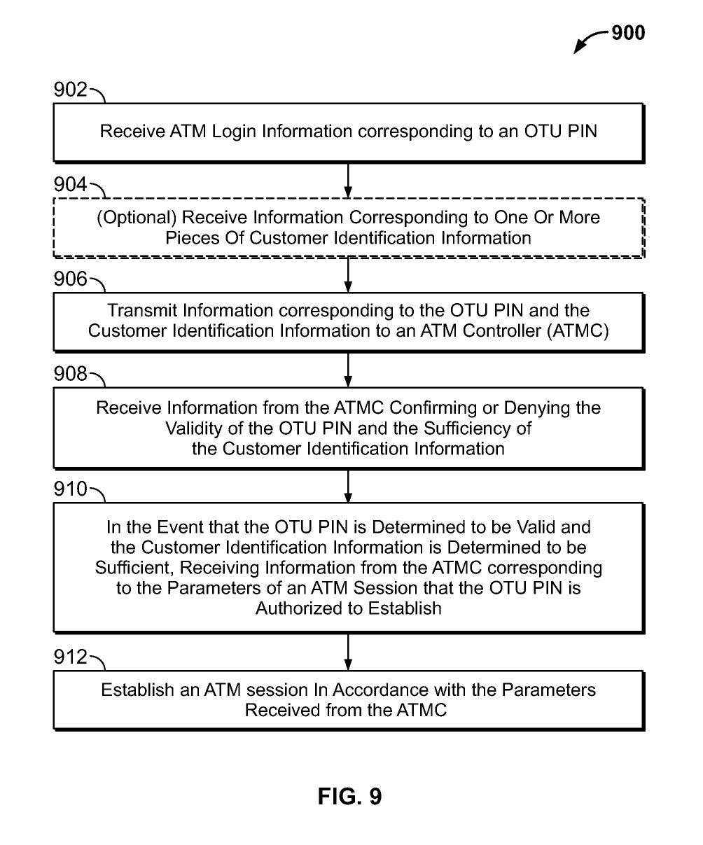

FIG. 9 illustrates exemplary process 900 in accordance with systems and methods of the invention. Process 900 may begin at step 902. At step 902, an ATM may receive login information corresponding to an OTU PIN. Process 900 may optionally continue at step 904. At step 904, the ATM may receive information corresponding to one or more pieces of customer identification information. Process 900 may continue at step 906. At step 906, the ATM may transmit information corresponding to the OTU PIN and the customer identification information to an ATM controller (ATMC). In some embodiments, at least part of the transmitted information may be transmitted in encrypted form.

At step 908, the ATM may receive information from the ATMC confirming or denying the validity of the OTU PIN and the sufficiency of the customer identification information. It should be noted that the ATMC may determine the validity or invalidity of the OTU PIN and the customer identification information by routing the information to a third party. The third party may be any desirable interbank network, banking system, software application and/or authorization system. The third party may execute a validity/invalidity determination and transmit information to the ATMC relating to the validity/invalidity determination. The ATMC may subsequently route the information received from the third party to the ATM.

In the event that the OTU PIN is determined to be valid and the customer identification information is determined to be sufficient, process 900 may continue at step 910. At step 910, the ATM may receive information from the ATMC corresponding to the parameters of an ATM session that the OTU PIN is authorized to establish. Process 900 may conclude at step 912. At step 912, the ATM may establish an ATM session in accordance with the parameters received from the ATMC.

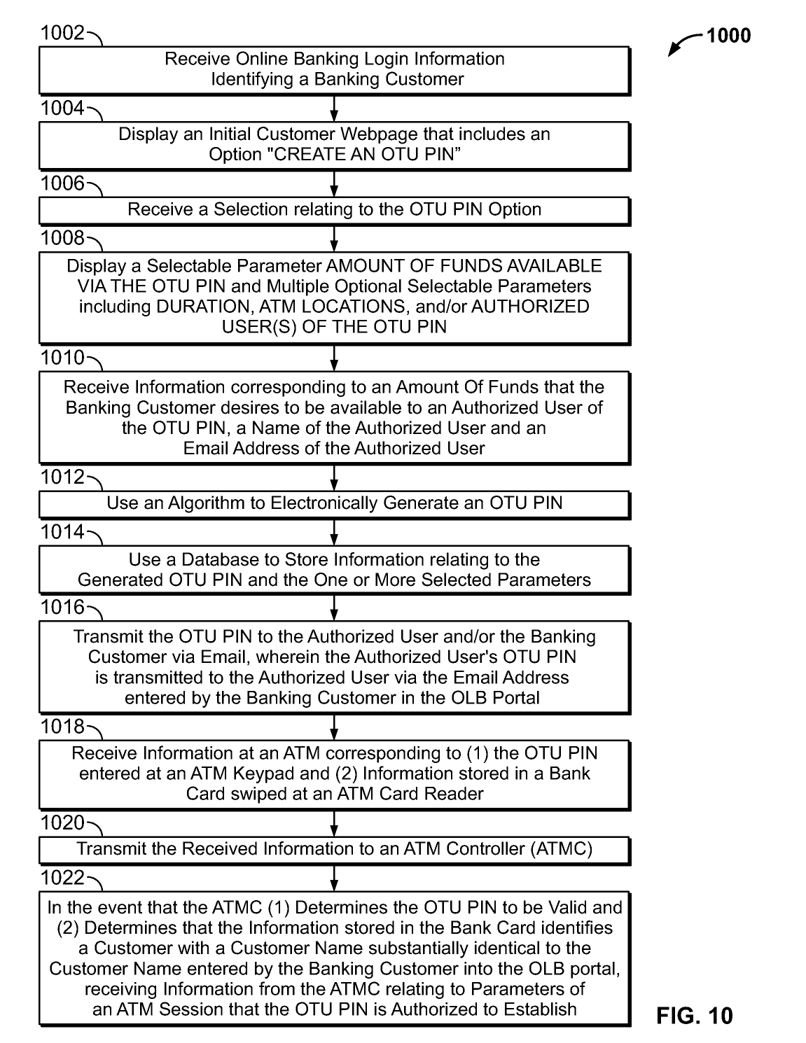

FIG. 10 illustrates exemplary process 1000 in accordance with systems and methods of the invention. Process 1000 may begin at step 1002. At step 1002, an OLB portal may receive OLB login information identifying a banking customer. At step 1004, the OLB portal may display an initial customer webpage that includes an option CREATE AN OTU PIN. At step 1006, the OLB portal may receive a selection relating to the OTU PIN option. Process 1000 may continue at step 1008. At step 1008, the OLB portal may display a selectable parameter AMOUNT OF FUNDS AVAILABLE VIA THE OTU PIN. At step 1008, the OLB portal may also display multiple optional selectable parameters including DURATION, ATM LOCATIONS and/or AUTHORIZED USER(S) OF THE OTU PIN. At step 1010, the OLB portal may receive information corresponding to an amount of funds that the banking customer desires to be available to an authorized user of the OTU PIN, a name of the authorized user and an e-mail address of the authorized user.

Process 1000 may continue at step 1012. At step 1012, the OLB portal may use an algorithm to electronically generate an OTU PIN. At step 1014, the OLB portal may use a database to store information relating to the generated OTU PIN and the one or more selected parameters. It should be noted that in some embodiments, at least part of the stored information may be stored in encrypted form.

At step 1016, the OLB portal may transmit the OTU PIN to the authorized user and/or the banking customer via email. The authorized user's OTU PIN may be transmitted to the authorized user via the email address entered by the banking customer in the OLB portal.

At step 1018, an ATM may receive information corresponding to (1) the OTU PIN entered at an ATM keypad and (2) information stored in a bank card swiped at an ATM card reader. At step 1020, the ATM may transmit the received information to an ATMC. In some embodiments, at least part of the transmitted information may be transmitted in encrypted form. In the event that the ATMC (1) determines the OTU PIN to be valid and (2) determines that the information stored in the bank card identifies a customer with a customer name substantially identical to the customer name entered by the banking customer into the OLB portal, process 1000 may continue at step 1022. At step 1022, the ATM may receive information from the ATMC relating to parameters of an ATM session that the OTU PIN is authorized to establish.

Thus, methods and apparatus for an OTU PIN according to the systems and methods of the invention have been provided. Persons skilled in the art will appreciate that the present invention can be practiced in embodiments other than the described embodiments, which are presented for purposes of illustration rather than of limitation, and that the present invention is limited only by the claims that follow.

What is claimed is:

1. Apparatus for generating an emergency one time use (EOTU) personal identification number (PIN) for use at one or more automated teller machines (ATMs), the apparatus comprising:
a receiver configured to receive:
information corresponding to an account holder at a financial institution; and
information corresponding a request from the account holder to electronically generate an EOTU PIN;
a processor configured to:
determine a maximum amount of funds to be accessed using the EOTU PIN; and
electronically generate the EOTU PIN;
a transmitter configured to electronically transmit to the account holder information relating to the EOTU PIN;
wherein:
the EOTU PIN expires upon the lapse of a predetermined amount of time.

2. The apparatus of claim 1, wherein the determination of the maximum amount of funds to be accessed using the EOTU PIN is based at least in part on an account holder account balance.

3. The apparatus of claim 1, wherein the determination of the maximum amount of funds to be accessed using the EOTU PIN is based at least in part on an account holder credit history.

4. The apparatus of claim 1, wherein the transmitter is configured to electronically transmit the information to the account holder via email.

5. The apparatus of claim 1, wherein the transmitter is configured to electronically transmit the information to the account holder via an automatically-generated phone call.

6. The apparatus of claim 1, wherein the transmitter is configured to electronically transmit the information to the account holder via text message.

7. The apparatus of claim 1, wherein the predetermined amount of time is a default amount of time.

8. The apparatus of claim 1, wherein the predetermined amount of time is selected by the account holder.

9. The apparatus of claim 1, wherein the funds to be accessed using the EOTU PIN are funds contained in an account holder bank account owned by the account holder.

10. An automated teller machine (ATM) that facilitates using an emergency one time use (EOTU) personal identification number (PIN) to establish an ATM session, the ATM comprising:
an ATM keypad configured to receive information corresponding to an EOTU PIN;
an ATM transmitter configured to transmit information corresponding to an encrypted version of the EOTU PIN to an ATM controller (ATMC);
an ATM receiver configured to receive information from the ATMC relating to the validity or invalidity of the EOTU PIN; and
in the event that the ATM receiver receives information relating to the validity of the EOTU PIN, an ATM central processing unit (CPU) configured to initiate an ATM session;
wherein:
the ATM session initiated by the ATM CPU provides an amount of funds to be withdrawn from an account holder's account, the amount of funds being less than a total amount of funds contained in the account holder's account; and
the EOTU PIN expires upon the lapse of a predetermined period of time.

11. The ATM of claim 10, wherein the EOTU PIN includes letters and numbers.

12. The ATM of claim 10, wherein the ATMC routes the received information to a third party to determine the validity or invalidity of the EOTU PIN.

13. The ATM of claim 12, wherein the third party is an interbank network.

14. The ATM of claim 12, wherein the third party is an authorization system.

15. The apparatus of claim 10, wherein the predetermined amount of time is a default amount of time.

16. The apparatus of claim 10, wherein the predetermined amount of time is user selected.
